(19) United States
(12) Patent Application Publication
(10) Pub. No.: US 2008/0237009 A1
(43) Pub. Date: Oct. 2, 2008

(54) SEALED SWITCH ASSEMBLY

(76) Inventors: Adam Weisz-Margulescu, Thornhill (CA); Salvatore Alesio, Newmarket (CA)

Correspondence Address: Lisa Burgin Vaccarelli;Tyco Technology Resources, Suite 140, 4550 New Linden Hill Road, Wilmington, DE, 19808, US

(21) Appl. No.: 12/057,141

(22) Filed: Mar. 27, 2008

Related U.S. Application Data
(60) Provisional application No. 60/920,232, filed on Mar. 27, 2007.

(51) Int. Cl. H01H 9/04

(52) U.S. Cl. 200/302.1

(57) ABSTRACT

A switch assembly includes a circuit board having at least one circuit and a switch mechanism supported by the circuit board. The switch mechanism is operated to close the circuit. A housing sealingly surrounds the circuit board and the switch mechanism. Optionally, the housing may be overmolded around the circuit board and the switch mechanism. The housing may be configured to be mounted to an exterior portion of a vehicle such that the switch mechanism may be operated by an operated from the exterior of the vehicle.

### CROSS REFERENCE TO RELATED APPLICATIONS

This application claims the benefit of U.S. Provisional Application No. 60/920,232 filed Mar. 27, 2007, the subject matter of which is herein incorporated by reference in its entirety.

### BACKGROUND OF THE INVENTION

The subject matter herein relates generally to electrical switch assemblies, and more particularly, to a simple, compact switch for use on an automobile tailgate, door, trunk and the like.

Tailgates, doors and trunks of automobiles typically include a latch assembly for opening the tailgate, door or trunk. The latch assembly may be activated via a button inside the car, a remote button, such as on a key fob, or manually at the latch assembly. Additionally, in some applications, the latch assembly may be located adjacent to, or in combination with, the license plate holder of the automobile.

The existing latch assemblies include manually activated mechanisms at the tailgate, door or trunk, which are mechanically linked to an internally mounted, electrical micro-switch. These latch assemblies require an externally mounted mechanically activated mechanism, such as a compressible or rotatable handle, a transfer mechanism, and an internally mounted electrical switch. Consequently, given the number and complexity of the components needed to open the tailgate, door or trunk used in current latch assemblies, these latch assemblies have additional costs. Additionally, in applications where the latch assembly is located adjacent the license plate holder, separate lighting devices are required to illuminate the license plate.

### BRIEF DESCRIPTION OF THE INVENTION

In one embodiment, a switch assembly is provided that includes a circuit board having at least one circuit and a switch mechanism supported by the circuit board. The switch mechanism is operated to close the circuit. A housing sealingly surrounds the circuit board and the switch mechanism. Optionally, the housing may be overmolded around the circuit board and the switch mechanism. The housing may be configured to be mounted to an exterior portion of a vehicle such that the switch mechanism may be operated by an operated from the exterior of the vehicle.

Optionally, the housing may be compressible at least in an actuation region proximate the switch mechanism such that pressing on the actuation region mechanically actuates the switch mechanism. The switch mechanism may include a dome switch being mechanically depressible from a non-depressed position and being configured to return to the non-depressed position. Optionally, the switch assembly may include a holder having an opening, wherein the switch mechanism is held within the opening by the holder. The holder may be mountable to the circuit board to hold the switch mechanism in position relative to the circuit board. The switch assembly may include a mounting bracket configured to be mounted to a frame, wherein the housing is securely coupled to the mounting bracket, and thus the frame.

In another embodiment, a switch assembly is provided that includes a circuit board having a switch circuit and a lighting circuit. A switch mechanism is coupled to the circuit board such that the switch mechanism may be actuated to close the switch circuit. A lighting assembly having a light source is coupled to the circuit board and is operatively coupled to the lighting circuit to operate the light source. A housing sealingly surrounds the circuit board, the switch mechanism, and the lighting assembly.

Optionally, the lighting assembly may include a frame mounted to the circuit board with the light source being held by the frame. The lighting assembly may include a lens covering the light source for directing light produced by the light source in a lighting pattern. The lens may have an emitting face, wherein the lens is aligned with the light source such that the emitting face is generally opposite the light source. The lens may extend through the housing such that the emitting face is substantially flush with an outer surface of the housing. Optionally, the lighting assembly may include a light pipe held by the housing, wherein the light pipe is aligned with the light source and directs the light produced by the light source to a predetermined location relative to the housing. The light source may be a light emitting diode.

### BRIEF DESCRIPTION OF THE DRAWINGS

FIG. 1 illustrates a latch system having a release mechanism operated by a switch assembly that is formed in accordance with an exemplary embodiment.

FIG. 2 is a partial cut-away, bottom perspective view of an exemplary switch assembly with a lighting assembly.

FIG. 3 is a cross-sectional view of the switch assembly shown in FIG. 2.

FIG. 4 is a bottom perspective view of the switch assembly and lighting assembly, illustrating an exemplary lighting pattern.

FIG. 5 is a bottom perspective view of a switch assembly using an alternative lighting assembly.

### DETAILED DESCRIPTION OF THE INVENTION

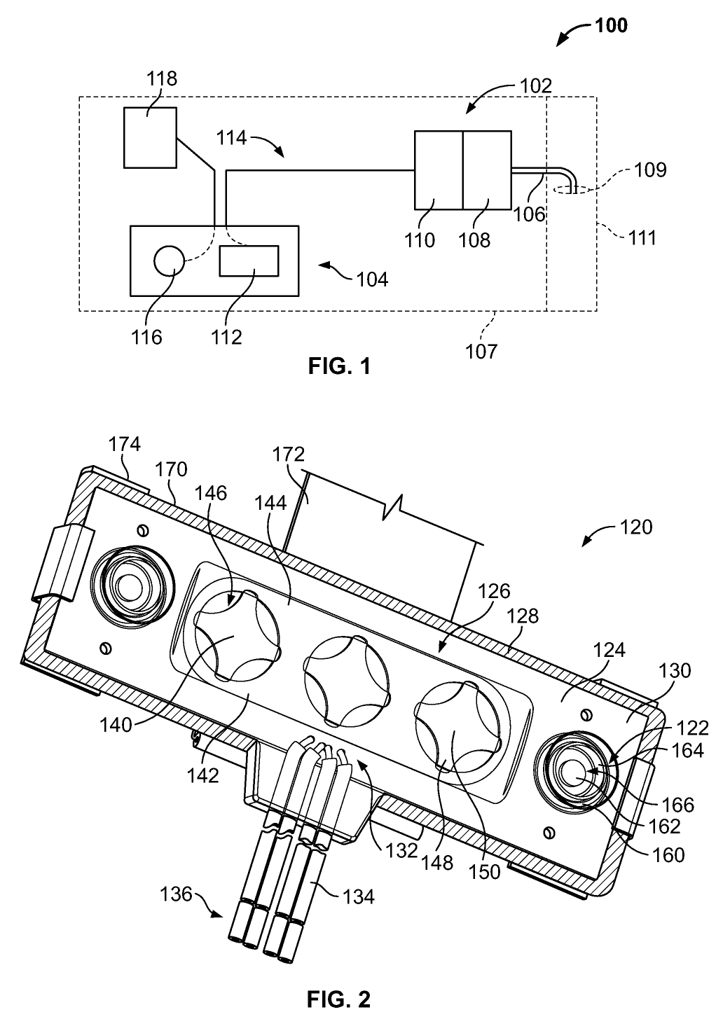

FIG. 1 illustrates a latch system 100 having a release mechanism 102 operated by a switch assembly 104 that is formed in accordance with an exemplary embodiment. In an exemplary embodiment, the latch system 100 is utilized in an automotive application, such as a door release, a tailgate release, a trunk release, and the like. However, it is to be understood that the benefits and advantages of embodiments of the latch system 100 described herein may accrue equally to other types of applications across a variety of systems. For example, the latch system 100 may be utilized in other types of motive applications or non-motive applications that utilize release mechanisms 102.

In an exemplary embodiment, the release mechanism 102 includes a latch 106 or other type of mechanical device that may be used to securely retain another component in a latched position, such as a door 107, which is illustrated schematically in FIG. 1. The latch 106 may be release to an unlatched position, in which the door may be opened. For example, the release mechanism 102 may include an actuator 108 that is operated to release the latch 106 to the unlatched position. The actuator 108 may be hydraulically actuated, mechanically operated, spring operated, magnetically operated, electrically operated, and the like. Upon actuation, the latch 106 is released, such as from a complementary latching member 109 that is attached to a frame 111 of the vehicle. In an exemplary embodiment, the release mechanism 102 includes a controller 110 that controls the operation of the actuator 108. For example, the controller 110 may receive electrical signals from the switch assembly to control the state of the actuator 108. Optionally, the controller may include a micro-processor.

The switch assembly 104 includes a switch mechanism 112 that may be operated by a user. Optionally, the switch 104 may be mounted to the door 107, or another structure of the vehicle, such that the switch mechanism 112 is accessible from the exterior of the door 107. The switch mechanism 112 may be a mechanical switch that is actuated to close an electrical circuit, thereby operating the release mechanism 102. Alternatively, the switch mechanism 112 may include electronics or other circuitry to close the electrical circuit, such as a capacitive switch. Optionally, the switch mechanism 112 may include a keypad or number pad that may be operated by the user to receive a code to operate the release mechanism 102. The switch assembly 104 includes a wire harness 114, or other type of wire or cable assembly that connects the switch mechanism 112 and the release mechanism 102. Alternatively, the switch mechanism 112 and the release mechanism 102 may communicate wirelessly.

In an exemplary embodiment, the switch assembly 104 includes a lighting assembly 116 for lighting either the switch assembly 104 or an area proximate the switch assembly 104. The lighting assembly 116 may be operatively coupled to a lighting management system 118, such as by the wire harness 114, or by a separate wire or cable. The lighting management system 118 may be mounted within the door 107, or alternatively, may be contained within another portion of the vehicle. The lighting management system 118 may include a power source and/or a controller, such as a microprocessor, for controlling the operation of the lighting assembly 116. The lighting assembly 116 may be operated independently of the switch mechanism 112, or alternatively, may be operated by the switch mechanism 112.

FIG. 2 is a partial cut-away, bottom perspective view of an exemplary switch assembly 120 with a lighting assembly 122. The switch assembly 120 may be used with the latch system 100 (shown in FIG. 1) in place of the switch assembly 104. The lighting assembly 122 may be used with the latch system 100 in place of the lighting assembly 116.

The switch assembly 120 includes a circuit board 124, a switch mechanism 126, the lighting assembly 122, and a housing 128. A portion of the housing 128 is cut-away to illustrate the circuit board 124, switch mechanism 126 and lighting assembly 122. The housing 128 is utilized to surround the circuit board 124, the switch mechanism 126 and the lighting assembly 122 and seal the internal components from the surrounding environment. The circuit board 124 has a switch circuit and a lighting circuit. The switch mechanism 126 is coupled to the circuit board 124 and may be actuated to close the switch circuit. For example, the switch mechanism 126 may be directly mounted to the circuit board 124 and electrically connected to circuits of the circuit board 124. The lighting assembly 122 is coupled to the circuit board 124 and is operatively coupled to the lighting circuit.

The circuit board 124 is generally planar and includes a bottom surface 130. The circuit board 124 includes plurality of traces that form portions of the switch circuit and the lighting circuit. For example, the traces may extend to and/or define a switch pad or a switch area that interacts with the switch mechanism during use of the switch assembly 120. The traces may be provided on the bottom surface 130, the surface opposite the bottom surface, and/or on intermediate layers of the circuit board 124 if a multi-layer board is used. A wire termination area 132 is provided on the bottom surface 130, and individual wires 134 from a wire harness 136 are terminated to the wire termination area 132. The wires 134 may be terminated by surface mounting or through hole mounting to the circuit board 124. Alternatively, contacts may be provided at the ends of the wires 134 for terminating to the circuit board 124. The wires 134 may be connected to the release mechanism 102 (shown in FIG. 1) and/or the lighting management system 118 (shown in FIG. 1).

The switch mechanism 126 is mounted to the circuit board 124, or otherwise positioned with respect to the circuit board 124, such that the switch mechanism 126 may be operatively connected to the switch circuit of the circuit board 124. In an exemplary embodiment, the switch mechanism 126 includes a plurality of dome switches 140 and a holder 142 that holds the dome switches 140 in place with respect to the circuit board 124. It is realized that other types of switches may be utilized in alternative embodiments, and the dome switches 140 are merely illustrative of one type of switch that may be used with the switch assembly 120. Additionally, while three dome switches 140 are illustrated, it is realized that any number of dome switches 140 may be provided in alternative embodiments.

The holder 142 includes a generally planar body 144 that includes a plurality of openings 146. The dome switches 140 are arranged within corresponding openings 146. The holder 142 may be positioned with respect to the circuit board 124, such as by using aligning features, such as ribs, tabs or pins that extend into slots, channel or holes in the circuit board 124 to position the openings of the holder 142, and thus the dome switches 140, in position with respect to the switch pads or switch areas defined by the traces. Optionally, the holder 142 may be secured to the circuit board using a fastener, an adhesive, and the like. Alternatively, the holder may be held in place with respect to the circuit board 124 by the housing 128.

The dome switches 140 are generally convex in shape to define a domed structure. In an exemplary embodiment, each dome switch 140 includes four legs 148 that extend outward from a central web 150. The web 150 is normally elevated with respect to the circuit board 124. The legs 148 support the web 150 and may engage the holder 142 and/or the circuit board 124. The dome switch may be mechanically depressible by a user from a non-depressed position (e.g. a normally convex position) to a depressed position. In the depressed position, the web 150 mechanically engages the switch pad defined on the circuit board to close the switch circuit. The dome switch 140 may be automatically returned to the non-depressed position when the dome switch 140 is released by the user. In the illustrated embodiment, the three dome switches 140 are aligned with one another along the longitudinal axis of the circuit board 124. Other placements of the dome switches 140 are possible in alternative embodiments. The number of dome switches 140 and the placement of the dome switches 140 may be selected to provide easy actuation by the user. For example, because the user naturally touches the center of the switch assembly 120, actuation is made more convenient by centering the dome switches 140 with respect to the switch assembly 120. Additionally, by increasing the number of dome switches 140, or alternatively, by increasing the size of the dome switches 140, the actuation area that the user has to positively actuate the switch assembly 120 is likewise increased.

The lighting assembly 122 includes a frame 160, a light source 162 and a lens 164. The frame holds the light source 162 and/or the lens 164 and is mounted to the circuit board 124. In an exemplary embodiment, the frame 160 is circular and includes a central opening 166. The light source 162 is received in the central opening 166 and may be terminated to, or otherwise electrically coupled to the lighting circuit of the circuit board 124. In an exemplary embodiment, the light source is a light emitting diode (LED), however other types of light sources may be utilized in alternative embodiments. In the illustrated embodiment, two lighting assemblies 122 are provided that flank the switch mechanism 126. The lighting assemblies 122 are arranged along the longitudinal axis of the circuit board 124. Other placements of the lighting assemblies 122 are possible in alternative embodiments. The number of lighting assemblies 122 and the placement of the lighting assemblies 122 may be selected to provide an amount and a position of the lighting as desired.

The housing 128 surrounds the circuit board 124 and other components of the switch assembly 120. The housing 128 includes an outer surface 170 that defines the outer surface of the switch assembly 120. Optionally, the housing 128 may include a strain relief or other structure that securely retains the wires 134 of the wire harness 136. In the exemplary embodiment, the housing 128 is formed by overmolding the other components of the switch assembly 120 to encompass the circuit board 124, switch mechanism 126 and lighting assembly 122. The housing 128 may be made from a thermal plastic rubber (TPR) such as Alcryn or the like. In the exemplary embodiment, the overmolded construction ensures IP 66 sealing.

Because the switching components of the switch assembly 120 are integrated into a common housing 128, the latch system 100 (shown in FIG. 1) requires fewer components which makes it more robust and economical. Additionally, when the switch assembly 120 includes one or more lighting assemblies 122, the compact assembly requires less space and incorporates both switching and lighting into the same module.

In an exemplary embodiment, the switch assembly 120 may include a mounting bracket 174. The mounting bracket 174 is configured to be mounted to a structure of the vehicle or device utilizing the latch system 100 (shown in FIG. 1). For example, the mounting bracket 174 may be mounted to a frame, door, tailgate or trunk of a vehicle utilizing the switch assembly 120. The mounting bracket 174 is positioned such that the switch assembly 120 is accessible from the exterior of the vehicle such that the user can actuate the switch mechanism 126. In an exemplary embodiment, the mounting bracket 174 includes a plurality of fingers 176 that engage and orient the switch assembly 120 with respect to the mounting bracket 174. For example, the fingers 176 may define a space that is sized and shaped complementary to the size and shape of the housing 128, as defined by the outer surface 170. The fingers 176 thus securely retain the housing 128.

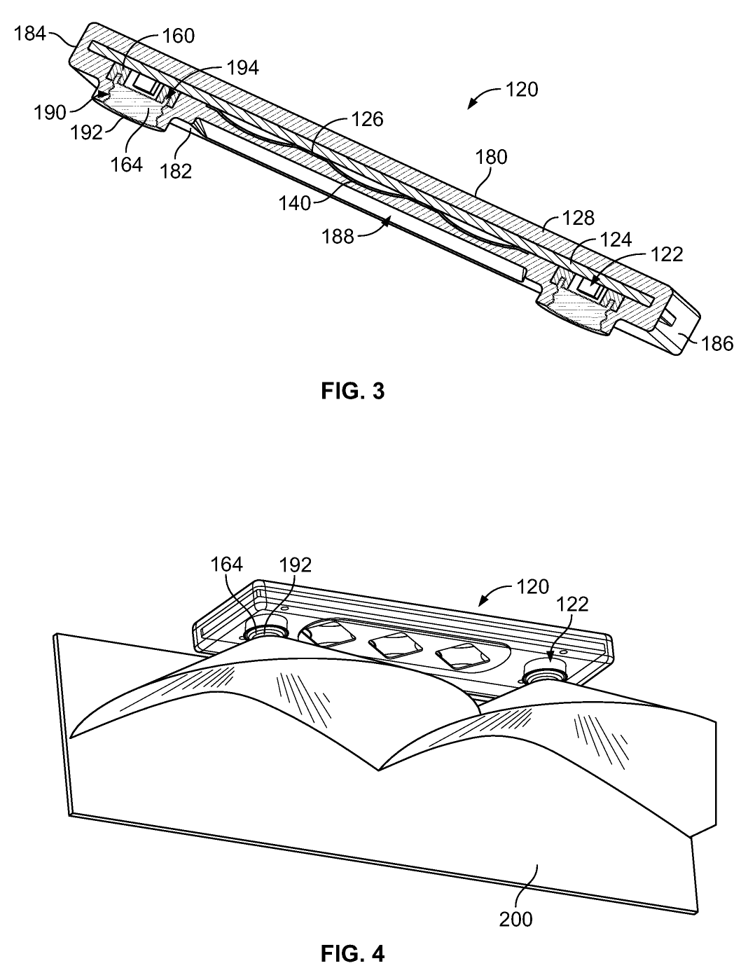

FIG. 3 is a cross-sectional view of the switch assembly 120 illustrating the housing 128 encasing the circuit board 124, the switch mechanism 126 and the lighting assemblies 122. As described above, the housing 128 may be overmolded around the components of the switch assembly 120, thus forming a sealed environment for the circuit board 124, the switch mechanism 126 and the lighting assemblies 122.

The housing 128 includes a top side 180, a bottom side 182 and opposed ends 184, 186. The circuit board 124 is held within the housing 128 such that the top and bottom sides 180, 182 are generally parallel with the circuit board 124. The bottom side 180 includes an actuation region 188 that is generally aligned with, and proximate to, the switch mechanism 126. The actuation region 188 is at least partially flexible and/or compressible such that pressing on the actuation region mechanically actuates the switch mechanism 126. Optionally, the actuation region 188 may be thinner as compared to other portions of the housing 128 to allow sufficient flexibility of the actuation region 188. In the illustrated embodiment having domed switches 140, pressing on the actuation region 188 with sufficient force depresses at least one of the dome switches 140, thus closing the switch circuit of the switch assembly 120.

The lighting assemblies 122 are provided to shine light outside of the housing 128. The housing 128 thus includes an opening 190 associated with each lighting assembly 122. In the illustrated embodiment, the opening 190 is generally aligned with the light source 162. The lens 164 fills the opening 190, and an emitting face 192 of the lens 164 is substantially aligned flush with the outer surface 170. The light emitted by the light source 162 is focused by the lens 164 and emitted to the surrounding environment through the emitting face 192. In an exemplary embodiment, the lens 164 is held within a ring 194 formed in the frame 160. Optionally, the lens 164 may be secured to the frame 160 using an adhesive. The lens 164 may be fabricated from any optical grade material, such as Polycarbonate material, hard Silicon material, or Aliphatic Polyurethanes, and the like.

FIG. 4 is a bottom perspective view of the switch assembly 120 and lighting assemblies 122, illustrating an exemplary lighting pattern. FIG. 4 also illustrates a surface 200 to be illuminated. In an exemplary embodiment, the surface 200 may be a license plate holder and/or the associated license plate that is provided on the back of an automotive vehicle. The switch assembly 120 and lighting assemblies 122 are mounted to the vehicle in such a position that the lighting assemblies 122 shine light on the license plate.

The light emitted through the emitting surfaces 192 of the lenses 164 is directed to the surface 200. Optionally, the position and orientation of the lenses 164 may be altered to change the lighting pattern. For example, positioning the lighting assemblies 122 closer to the surface 200 may alter the portion of the surface 200 illuminated. Additionally, the structure of the lenses 164 may be altered to change the lighting pattern, such as by directing or focusing the light in a certain direction.

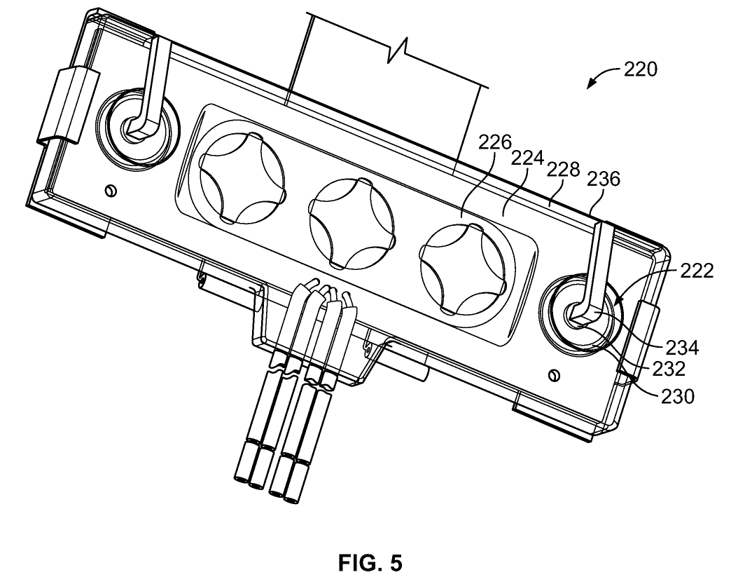

FIG. 5 is a bottom perspective view of a switch assembly 220 using alternative lighting assemblies 222. The switch assembly 220 is substantially similar to the switch assembly 120, including a circuit board 224, a switch mechanism 226 and a housing 228.

The lighting assemblies 222 are attached to the circuit board 224 and include a frame 230, a light source 232 and a light pipe 234. The frame holds the light source 232 and/or the light pipe 234 and may be secured to the circuit board 224 in any manner. The light pipes 234 are utilized to direct the light from the light source 232 to a predetermined region of the switch assembly 220. For example, the light pipes 234 may direct the light to the exterior of the housing 228 near an edge 236 of the housing 228. The light pipes 234 may be positioned to direct the light in any desired direction, thus controlling the lighting pattern. In an exemplary embodiment, the light pipes 234 are at least partially encased in the housing 228.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means—plus-function format and are not intended to be interpreted based on 35 U.S.C. § 112, sixth paragraph, unless and until such claim limitations expressly use the phrase “means for” followed by a statement of function void of further structure.

What is claimed is:

1. A switch assembly comprising:
a circuit board having at least one circuit;
a switch mechanism supported by the circuit board, the switch mechanism being operated to close the circuit; and
a housing that sealingly surrounds the circuit board and the switch mechanism.

2. The switch assembly of claim 1, wherein the housing is overmolded around the circuit board and the switch mechanism.

3. The switch assembly of claim 1, wherein the housing is configured to be mounted to an exterior portion of a vehicle such that the switch mechanism may be operated by an operated from the exterior of the vehicle.

4. The switch assembly of claim 1, wherein the housing is compressible at least in an actuation region proximate the switch mechanism such that pressing on the actuation region mechanically actuates the switch mechanism.

5. The switch assembly of claim 1, wherein the switch mechanism comprises a dome switch being mechanically depressible from a non-depressed position and being configured to return to the non-depressed position.

6. The switch assembly of claim 1, further comprising a holder having an opening, the switch mechanism being held within the opening by the holder, the holder being mountable to the circuit board to hold the switch mechanism in position relative to the circuit board.

7. The switch assembly of claim 1, further comprising a lighting assembly having at least one light source coupled to the circuit board and sealingly surrounded by the housing.

8. The switch assembly of claim 1, further comprising a mounting bracket configured to be mounted to a frame, the housing being securely coupled to the mounting bracket.

9. A switch assembly comprising:
a circuit board having a switch circuit and a lighting circuit;
a switch mechanism coupled to the circuit board, the switch mechanism being configured to be actuated to close the switch circuit;
a lighting assembly having a light source coupled to the circuit board, the lighting assembly being operatively coupled to the lighting circuit to operate the light source; and
a housing that sealingly surrounds the circuit board, the switch mechanism and the lighting assembly.

10. The switch assembly of claim 9, wherein the lighting assembly includes a frame mounted to the circuit board, the light source being held by the frame.

11. The switch assembly of claim 9, wherein the lighting assembly includes a lens covering the light source for directing light produced by the light source in a lighting pattern.

12. The switch assembly of claim 9, wherein the lighting assembly includes a lens having an emitting face, the lens being aligned with the light source such that the emitting face is generally opposite the light source, the lens extending through the housing such that the emitting face is substantially flush with an outer surface of the housing.

13. The switch assembly of claim 9, wherein the lighting assembly includes a light pipe held by the housing, the light pipe being aligned with the light source and directing light produced by the light source to a predetermined location relative to the housing.

14. The switch assembly of claim 9, wherein the light source is a light emitting diode.

15. The switch assembly of claim 9, wherein the housing is overmolded around the circuit board and the switch mechanism.

16. The switch assembly of claim 9, wherein the housing is made from a thermal plastic rubber material.

17. The switch assembly of claim 9, wherein the housing is compressible at least in an actuation region proximate the switch mechanism such that pressing on the actuation region mechanically actuates the switch mechanism.

18. The switch assembly of claim 9, wherein the switch mechanism comprises a dome switch being mechanically depressible from a non-depressed position and being configured to return to the non-depressed position.

19. The switch assembly of claim 9, further comprising a holder having an opening, the switch mechanism being held within the opening by the holder, the holder being mountable to the circuit board to hold the switch mechanism in position relative to the circuit board.

20. The switch assembly of claim 9, further comprising a mounting bracket configured to be mounted to a frame, the housing being securely coupled to the mounting bracket.
